(19) United States
(12) Patent Application Publication
(10) Pub. No.: US 2004/0207995 A1
(43) Pub. Date: Oct. 21, 2004

(54) Light unit for display device

(76) Inventors: Jong Hwa Park, Kwangmyung (KR); Young Gi Kim, Suwon (KR); Chang Jin Park, Yongin (KR); Dae Young Yun, Seoul (KR); Chan Soo Kim, Suwon (KR)

Correspondence Address: LOWE HAUPTMAN GOPSTEIN GILMAN & BERNER, LLP, Suite 310, 1700 Diagonal Road, Alexandria, VA, 22314, US

(21) Appl. No.: 10/461,512

(22) Filed: Jun. 16, 2003

(30) Foreign Application Priority Data
Apr. 18, 2003 (KR) 2003-24647

(51) Int. Cl. F21V 7/04

(52) U.S. Cl. 362/31; 362/330; 362/260

(57) ABSTRACT

Disclosed is a light unit used for backlighting a display device such as an LCD panel, which emits perpendicularly-directed white surface light by using lateral monochromatic light. The light unit of the invention comprises: a monochromatic light source for emitting monochromatic light; a light guide plate placed at the side of the monochromatic light source, and having a hologram pattern formed on at least one of front and rear faces oriented perpendicular to incident light introduced from the monochromatic light source for emitting light in a direction substantially perpendicular to the incidence direction of light; and a fluorescent layer applied on the front face of the light guide plate for converting perpendicularly-directed emitted light into white light.

### BACKGROUND OF THE INVENTION

1. Field of the Invention

The present invention relates to a light unit used for backlighting a display device such as an LCD panel, and more particularly, to a light unit for a display device which emits perpendicularly-directed white surface light by using lateral monochromatic light.

2. Description of the Related Art

Recently, Liquid Crystal Display (LCD) panels have been widely employed in personal computers, flat TVs, mobile telephones and so on. The LCD panels each are mounted with a surface lighting device so-called a backlight (i.e. surface light source) The backlight is adapted to convert linear light from for example a cold cathode discharge tube into surface light.

There are several techniques for constituting the backlight, in which a light source is installed under a rear face of an LCD panel, a light source is placed at the side of a transparent waveguide or light guide plate such as an acrylic plate for converting light into surface light to realize a surface light source (i.e., lateral lighting technique), or an optical element such as a prism array is installed in a light emitting face to obtain desired optical characteristics.

In the technique of installing the lateral light source and the light guide plate, a prism sheet 19 is used as shown in FIG. 1, which illustrates a conventional light unit employing the prism sheet 19.

As shown in FIG. 1, the conventional light unit comprises a light guide plate 4, a white light source 10 placed at the side of the light guide plate 4 and a reflector 11 placed under the light guide plate 4. Also, a diffuser plate 18, a prism sheet 19 and a protective sheet 20 are disposed over the light guide plate 4. A scattering pattern is provided on the underside of the light guide plate 4 by printing a dot pattern or forming a printless pattern 17 such as V-shaped grooves.

The following description will present the operation of the light unit in FIG. 1. First, the white light source 10 emits light into the light guide plate 4, where light is scattered by the scattering pattern 17. Scattered light exits from the light guide plate 4 at an incidence angle smaller than the angle of total reflection, and propagates toward the diffuser plate 18. The diffuser plate 18 sends uniform brightness of light to the prism sheet 19, which emits collected light via its front surface.

Because the light unit scatters light via the dot pattern printed on the light guide plate or the V-shaped grooves carved thereon, light which propagates toward the LCD panel from the light guide plate is emitted at a relatively large angle of about 50 to 90 degree about a normal line of the light guide plate. Redirecting such light in a direction perpendicular in respect to the light guide plate requires additional elements such as a prism in addition to the diffuser plate 18. Therefore, the prism sheet 19 is placed over the diffuser plate 18 to convert perpendicularly-directed light.

Because the light unit has the scattering pattern dispersed in a portion of the light guide plate, light is emitted only from a portion having the dot pattern so that the efficiency of the light guide plate depends only on the position and area of the dot pattern. When assembled to the LCD panel, however, the printed dot pattern tends to cause blurs on respective pixels of a screen and deteriorate visibility. Although the diffuser plate is utilized in order to overcome the problem of poor visibility, luminous efficiency degrades according to the transmittance of the diffuser plate.

The afore described conventional light unit has several problems in that a number of parts such as the diffuser plate and the prism sheet are required, visibility is poor and luminous efficiency degrades according to the transmittance of the diffuser plate.

FIG. 2 illustrates a light source unit disclosed in Japanese Laid-Open Patent Application Serial No. 2001-332113. The light source unit in FIG. 2 includes a luminous body 21 as a light source for emitting various wavelengths of light and a light guide plate 22 for guiding light emitted from the luminous body to an object to be lighted. The light guide plate 22 has a hologram formed on a face thereof opposed to the object to be lighted, which reproduces light into diffraction light containing chromatic aberration and projects diffraction light as luminous light in a direction substantially perpendicular to the face opposed to the object to be lighted.

As the light unit shown in FIG. 2 currently becomes thinner and simpler, a light guide plate having a hologram pattern without a prism sheet is getting used. Such a light unit comprises a typical white light source 31 and a hologram diffraction pattern 38. Describing a basic operation of the light unit, incident light 32 remains within a light guide plate 36 resulting from total reflection by the light guide plate 36. The hologram pattern 38 on the underside of the wave guide 36 diffracts a portion of light projected thereto, which is reflected by a reflector 37 under the light guide plate 36 and emitted out of the light guide plate 36.

The white light source 31 introduces multichromatic light into the light guide plate 36, in which diffraction creates path differences to multichromatic light according to wavelengths, thereby causing chromatic aberration. That is, incident light 32 is diffracted into a red beam 33, a blue beam 34 and a green beam 35 according to wavelengths, creating chromatic aberration (chromatic dispersion). Such chromatic aberration degrades the performance and efficiency of light emitted from the light unit and thus requires a solution or a color mixing technique to overcome the same.

The afore described light unit has drawbacks, however, in that in order to realize selective diffraction of a desired wavelength, a hologram master pattern is complicated and has more process steps or a diffuser plate for color mixture is required.

### SUMMARY OF THE INVENTION

The present invention has been made to solve the foregoing problems and it is therefore an object of the present invention to provide a light unit which can perpendicularly emit incident light, clear hologram of chromatic aberration or dispersion, impart uniform brightness to emitted light, and improve brightness efficiency.

It is another object of the invention to overcome the necessity of conventional optical elements such as a prism sheet for changing an optical path to provide a light unit thinner than conventional ones, thereby reducing the size of an article.

According to an aspect of the invention, there is provided a light unit for a display device, comprising: a monochromatic light source for emitting monochromatic light; a light guide plate placed at the side of the monochromatic light source, and having a hologram pattern formed on at least one of front and rear faces oriented perpendicular to incident light introduced from the monochromatic light source for emitting light in a direction substantially perpendicular to the incidence direction of light; and a fluorescent layer applied on the front face of the light guide plate for converting perpendicularly-directed emitted light into white light.

In the light unit for a display device of the invention, the monochromatic light source may comprises a blue light source for emitting blue light, and the hologram pattern may be formed on both of the front and rear faces of the light guide plate. the fluorescent layer preferably contains Yttrium Aluminum Garnet (YAG) powder and binder for enabling application of the fluorescent layer on the light guide plate, the binder more preferably comprises transparent resin. Preferably, the hologram pattern has a diffraction pitch of about 0.1 to 50 μm, and more preferably, the hologram pattern has a diffraction pitch of about 0.1 to 5 μm.

According to another aspect of the invention, there is provided a light unit for a display device, comprising: a monochromatic light source for emitting monochromatic light; a light guide plate placed at the side of the monochromatic light source, and having a hologram pattern formed on at least one of front and rear faces oriented perpendicular to incident light introduced from the monochromatic light source for emitting light in a direction substantially perpendicular to the incidence direction of light; a reflector placed under the rear face of the light guide plate; and a fluorescent layer applied on the front face of the light guide plate for converting perpendicularly-directed emitted light into white light.

In the light unit for a display device of the invention, the monochromatic light source may comprises a blue light source for emitting blue light, and the hologram pattern may be formed on both of the front and rear faces of the light guide plate. the fluorescent layer preferably contains Yttrium Aluminum Garnet (YAG) powder and binder for enabling application of the fluorescent layer on the light guide plate, the binder more preferably comprises transparent resin. Preferably, the hologram pattern has a diffraction pitch of about 0.1 to 50 μm, and more preferably, the hologram pattern has a diffraction pitch of about 0.1 to 5 μm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a conventional light unit using a prism sheet;

FIG. 2 is a perspective view of a light source unit disclosed in Japanese Laid-Open Patent Application Serial No. 2001-332113;

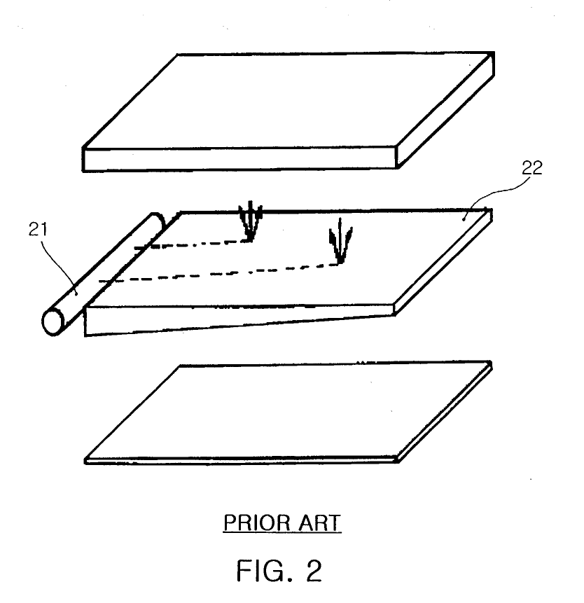

FIG. 3 illustrates light emitted from the light source unit in FIG. 2;

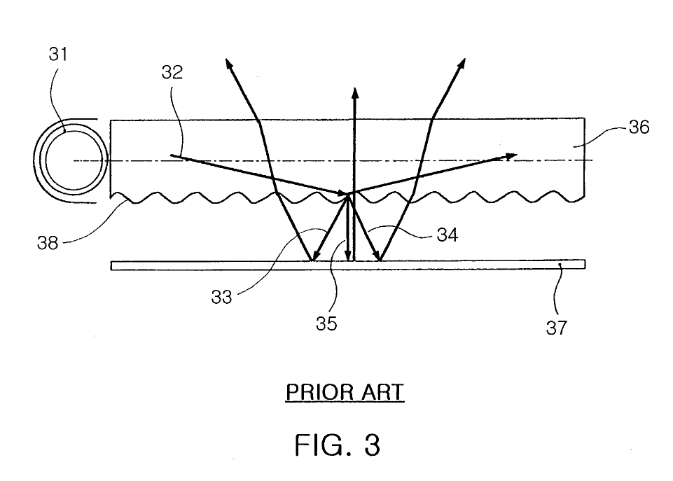

FIG. 4 is a sectional view of a light unit of the invention;

FIG. 5 illustrates a hologram pattern in the light unit of the invention;

FIG. 6 is a flowchart schematically illustrating a fabrication process of the hologram pattern in the light unit of the invention; and

FIG. 7 is a sectional view of a light unit according to an alternative embodiment of the invention.

### DETAILED DESCRIPTION OF THE PREFERRED EMBODIMENT

The following detailed description will present the invention in reference with the appended drawings. The light unit of the invention comprises a monochromatic light source for emitting monochromatic light, a waveguide or a light guide plate having a hologram pattern formed thereon and a fluorescent layer for converting monochromatic light into white light.

Light Source

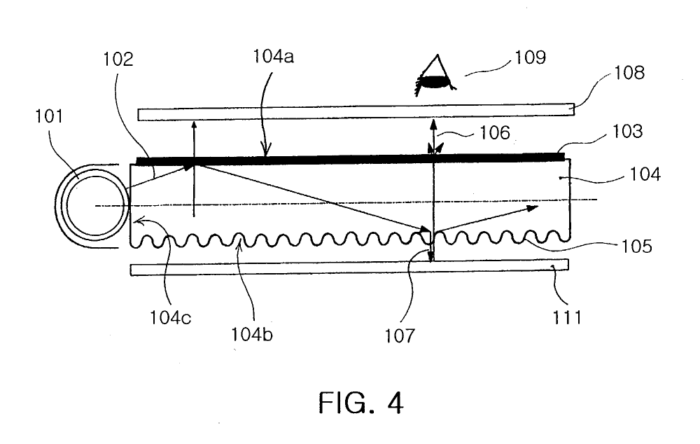

FIG. 4 is a sectional view of a light unit of the invention. The light unit of the invention comprises a light guide plate 104 made of a light-transmitting panel and a linear monochromatic light source 101 disposed at one lateral end of the light guide plate 104. Available examples of the monochromatic light source 101 may include a fluorescent tube, an LED array and so on, but they are not to be construed as the limit of the invention. In particular, the monochromatic light source 101 may employ a cold cathode tube, which is excellent in luminous efficiency and reducible in size.

The monochromatic light source 101 is preferably a blue light source emitting blue light of a wavelength in a range of about 360 to 500 nm. Blue light is converted into white light by a fluorescent layer 103, which will be described later.

Light Guide Plate

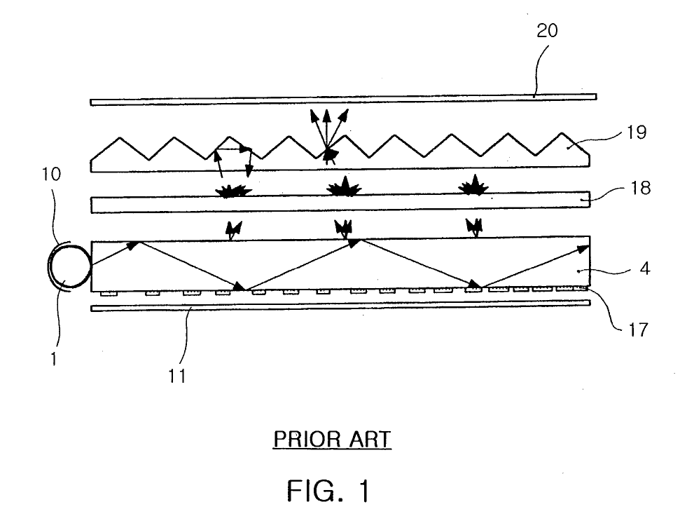

The light guide plate or light guide plate 104 is placed at the side of the monochromatic light source 101. The light guide plate 104 includes a front face 104a, a rear face 104b and an incident lateral face 104c formed between the front face 104a and the rear face 104b like the light guide plate shown in FIG. 1. In FIG. 4, the front face 104a faces the observer 109, whereas the rear face 104c faces away from the observer 109. The monochromatic light source 101 is installed adjacent to the incident lateral face 104c.

The light guide plate 104 is in the form of a quadrangular light-transmitting panel, which is made of a proper material having a transparency according to the wavelength range of the light source. Available examples of the material used in the range of visible light may include transparent resin, glass and so on. Transparent resin may include acrylic resin, polycarbonate resin, epoxy resin, and etc. The light guide plate 104 can be formed for example by cutting.

In the invention, the light guide plate 104 has a hologram pattern formed on at least one of the front and rear faces 104a and 104b. The hologram pattern functions to emit incident light 102 in a direction substantially perpendicular in respect to the incident direction thereof.

Hologram Pattern

The hologram pattern is formed on one of the front and rear faces 104a and 104b of the light guide plate 104. The hologram pattern functions as a diffraction pattern for diffracting light. In order to obtain a desired diffraction angle according to the wavelength of incident light, the shape and pitch of the hologram pattern can be variously adjusted as will be described later.

The hologram diffraction pattern or grating comprises as a number of parallel lines carved on a flat glass plate or a concave metal plate to an equal interval. If lighted, the hologram diffraction grating splits transmitted or reflected light according to wavelengths, thereby obtaining the spectrum of light. If a group of parallel beams are projected to the diffraction grating (made of a flat glass plate), some of the beams are absorbed or scattered by lined regions of the grating but other portions of the beams transmit narrow regions of the grating without the lines. In this case, the transmitted beams do not propagate straight but emanate in the form of a cylinder, diffracted according to Huygens' Principle.

Because the monochromatic light source is employed in the invention, where the hologram diffraction grating is applied, transmitting light can be adjusted to a desired angle. This configuration is discriminated from other common diffraction gratings each comprising slits so that light can pass through the slits while being absorbed by other blind regions except for the slits.

Hologram is divided into reflection hologram and transmission hologram according to regeneration modes. In transmission hologram, a hologram pattern is lighted from behind to regenerate an image so that the image can be observed in front of the hologram pattern. This technique projects light forward via a reflector placed behind the hologram pattern as in the invention. On the contrary, reflection hologram lights the hologram pattern from front so that an image reflected from the hologram pattern can be regenerated and observed in front of the hologram.

In a conventional process for forming a conventional diffraction grating in the light guide plate, aluminum was deposited on a high precise glass plate via vacuum plating and then a diamond tool was used to mechanically draw lines on Al-deposited regions of the glass plate. This process has drawbacks in that a long time period is required for fabrication of the diffraction grating, lines tend to be bent, and intervals between adjacent lines are not uniform.

On the contrary, holography technique can readily fabricate the diffraction grating at a uniform and very narrow inter-grating interval, in which resolving power up to about 10,000 lines/mm can be obtained according to photosenstive materials.

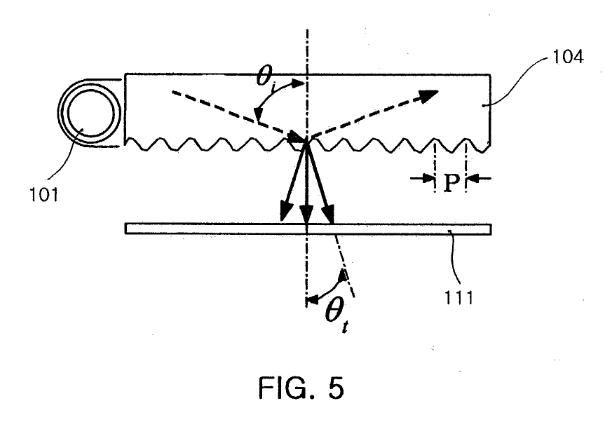

FIG. 5 illustrates light emission by a hologram pattern of the invention. Because light incident to the hologram pattern of the invention comprises monochromatic wavelength, appreciation will not be made to incidence and emission angles according to wavelengths as in the spectrum of general white light but only to those of monochromatic wavelength.

In FIG. 5, incident light from the light source continuously remains in the light guide plate through total reflection. In order to emit light in a desired direction, the diffraction pattern is formed on a surface of the light guide plate to create directed light, which is greatly related to a pitch of the diffraction pattern. The pitch is expressed according to Equation 1:

P=mλ/(n₂ sin Θₜ−n₁ sin Θᵢ) Equation 1,

wherein, P indicates pattern pitch, m indicates diffraction degree, λ indicates wavelength, n₁ and n₂ indicate refraction indexes, Θₜ indicates emission angle, and Θᵢ indicates incidence angle.

As can be seen above, the pattern pitch can be determined according to Equation 1.

Exemplifying a system comprising a light source which emits light of about 440 nm wavelength, the refraction index of the light guide plate is generally about 1.5, and thus the angle of total reflection is about 41.8 degree or more. If a beam having an incidence angle of 55 degree is perpendicularly diffracted at an emission angle of 90 degree, the pitch will be about 360 nm according to Equation 1.

The average angle of incidence may be varied according to the distance from the light source in FIG. 5 as well as the relation about the monochromatic light wavelength used in Equation 1, and thus the diffraction pattern pitch for emitting light toward the observer can be varied also. Therefore, it is required to properly consider the size of the light guide plate and the wavelength of the light source in formation of the diffraction pattern pitch.

In Equation 1, the diffraction pitch is preferably in a range of about 0.1 to 50 μm according to the wavelength of light and its incidence and emission angles. This range is obtained by calculating all potential incidence angles and emission angles. In a group of blue beams, if emission range conditions are obtained in a substantially perpendicular direction considering the incidence and emission angles within the above wavelength range, the pitch will be more preferably in a range of about 0.1 to 5 μm. In this range, a blue beam is diffracted at an incidence angle of about 42 to 89 degree and an emission angle of about −65 to 65 degree.

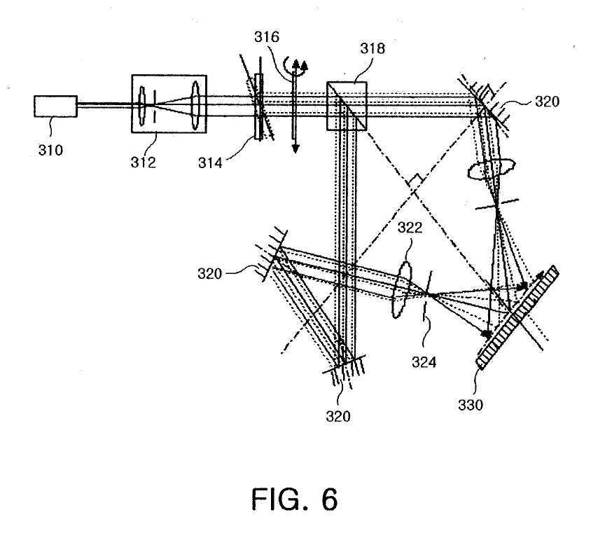

In order to obtain the above diffraction pattern, exposure technique as shown in FIG. 6 can be used. In this exposure technique, a photo-register is shaped via exposure to a laser beam using the coherence of the laser beam. The configuration of the shaped photo-register can be applied to mass production via stamping duplication.

As shown in FIG. 6, a beam from a laser 310 propagates through a beam diffuser 312 and then X and Y axial drives 314 and 316. The beam is split by a beam splitter (B/S) 318. The beam propagates in the form of a reference beam and an object beam, in which a reflector 320 is used to generate the phase difference between the two beams based upon the passage difference thereof. A special filter having an object lens 322 and a pin hole 324 clears light of noise and so on in order to obtain uniformly diffused light. Such uniformly diffused light is illuminated on a glass plate 330 coated uniformly with a photo-register. The diffraction pattern pitch depending on the coherency based upon the phase difference of the two beams is adjusted by the included angle of the two beams, in which the depth of the pattern is adjustable according to the amount of exposure.

A hologram diffraction pattern 105 is formed on at least one of the front and rear faces 104a and 104b of the light guide plate 104. FIG. 4 shows the hologram diffraction pattern formed on the rear face of the light guide plate.

In FIG. 4, light is introduced from the blue light source 101 into the light guide plate 104, where light remains resulting from total reflection from mirror planes of the light guide plate based upon the incidence angle of light.

As total reflected light collides against the front face 104a or the rear face 104b having the diffraction pattern, a portion thereof undergoes diffraction in a perpendicular direction, overcoming the condition of total reflection. Light diffracted from the rear face is emitted toward the reflector 111, and reflected therefrom toward the front face opposed to the diffraction pattern, resulting in perpendicular diffraction. Light of perpendicular diffraction is energized by the fluorescent layer 103, by which blue light is converted into white light before emission.

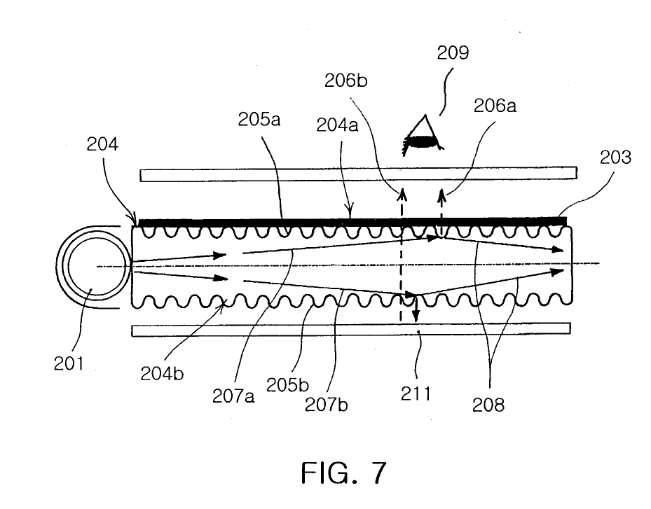

Alternatively, the hologram diffraction pattern can be formed on the front face of the light guide plate, or in both of the front and rear faces of the light guide plate. FIG. 7 illustrates exemplary hologram patterns formed on front and rear faces of a light guide plate.

In FIG. 7, hologram patterns 205a and 205b are formed respectively on front and rear faces 204a and 204b of a light guide plate 204. As light is introduced to the hologram pattern 205b in the rear face 204b, a portion of light is emitted perpendicularly downward by the hologram pattern 205b. The light portion is reflected from the reflector 211 in rear of the hologram pattern 205b toward the front face 204a of the light guide plate 204, and emitted to the outside from the front face 204a.

As light is also introduced to the hologram pattern 205a in the front face 204a of the light guide plate 204, a portion of light is emitted perpendicularly upward by the hologram pattern 205a.

In this case, the remaining portion 208 of light, which is not emitted, circulates within the light guide plate via reflection. In FIG. 7, the reference number 203 indicates a YAG fluorescent layer (YAG is a short form of Yttrium Aluminum Garnet), and 201 indicates a monochromatic light source. The construction in FIG. 7 emits light 206a and 206b in a perpendicular direction.

Fluorescent Layer

The invention applies the fluorescent layer on the front face 104a of the light guide plate 104 to convert light from the monochromatic light source into white light of multi-wavelength. Light 107, which is emitted perpendicularly rearward via the hologram pattern 105 formed on the light guide plate 104, is reflected from the reflector 111 toward the front face 104a of the light guide plate 104. At this time, light passes through the fluorescent layer 103 coated on the front face 104a of the light guide plate 104, by which monochromatic blue light 107 is converted into white light 106 of multi-wavelength.

The fluorescent layer comprises yellow YAG fluorescent powder, which can induce wavelength conversion of blue light into white light, and binder mixed with YAG fluorescent powder for enabling application of the fluorescent layer on the light guide plate. The ratio of binder mixed into YAG fluorescent powder can be varied according to the wavelength of blue light and brightness distribution thereof.

Herein YAG or a short form of Yttrium Aluminum Garnet indicates a solid laser material as a laser medium which oscillates owing to optical excitation. YAG is garnet obtained by synthesizing yttrium and aluminum, and getting most actively commercialized as a representative material since YAG crystals have excellent properties for the laser medium. YAG has a cubic crystal garnet structure which is physically and chemically stable, and shows a Mohs' hardness of about 8.5 and Young's Modulus of about 4 times of that of glass.

As a fluorescent material having high quantum efficiency, YAG also has properties such as an energy level structure for readily realizing negative (minus) temperature state, and high conductivity. Also, YAG is remarkably physically and chemically stable, rarely undergoes coloration or excessive absorption under strong excitation light and oscillation light, and can realize an optically uniform preform.

The fluorescent layer of the invention employs a YAG fluorescent layer as described above. In general, a technique of converting blue light into white light has been known in the LED field. In practical application of the conversion technique, the invention perpendicularly directs blue light via diffraction to the fluorescent layer containing mixture of yellow YAG fluorescent powder and binder resin so that the fluorescent layer is excited. Herein available examples of binder resin may include acrylic resin, UV curing epoxy resin and thermosetting resin. Transparent whitish cloudy or achromic resin is preferably selected in order to reduce optical loss.

Mixed fluorescent material can be coated on the surface of the light guide plate to a desired thickness via printing.

Reflector

The reflector 111 is placed under the lower face 104b of the light guide plate 104. The reflector 111 reflects emitted light, which is perpendicularly emitted from the light guide plate 104 by the hologram pattern 105, to a space front of the light guide plate 104. The reflector 111 also functions to assist diffusion of light within the light guide plate 104.

The reflector may comprise a suitable reflecting layer of the prior art, for example, a covering layer containing high refractive metal powder such as Al, Ag, Au, Cu and Cr in resin. Alternatively, the reflector may comprise a metal thin film formed via vapor deposition or a white plastic plate.

Operation

The invention is characterized in that the monochromatic light source is placed at the side of the light guide plate, monochromatic light from the monochromatic light source is perpendicularly emitted via the hologram pattern formed on the light guide plate, and emitted light passes through the fluorescent layer to convert into white multi-wavelength light again.

According to the invention, the hologram diffraction pattern is formed on at least one of the front and rear faces of the light guide plate.

FIG. 4 illustrates the hologram diffraction pattern formed on the rear face 104b of the light guide plate 104. In FIG. 4, light emitted from the blue light source 101 is introduced into the light guide plate 104, and light in a specific range of incidence angles remains within the light guide plate 104 resulting from total reflection by the mirror planes of the light guide plate 104.

When collided against the front face 104a and/or the rear face 104b of the diffraction pattern, a portion of light is perpendicularly diffracted in an angle range smaller than the angle of total reflection. Light diffracted by the rear face 104b is emitted toward the reflector 111, which perpendicularly reflects light toward the front face placed opposite to the diffraction pattern. Then, light is converted into white light via energization of the fluorescent layer before being emitted therefrom. Emitted light propagates to the observer 109 via the LCD pattern 108.

Further, the hologram pattern may be formed on the front face or both of the front and rear faces of the light guide plate. FIG. 7 illustrates hologram patterns formed on both of the front and rear faces of the light guide plate.

In FIG. 7, the hologram patterns 205a and 205b are formed respectively on the front and rear faces 204a and 204b of the light guide plate 204. When light is introduced to the hologram pattern 205b formed on the rear face 204b, a portion of light is emitted perpendicularly downward via the hologram pattern 205b, and reflected from the reflector 211 placed in rear of the light guide plate 204 to propagate toward a space in front of the light guide plate.

Also, as light 207a is introduced to the hologram pattern 205a formed on the front face 204a of the light guide plate, a portion of light 207a is emitted perpendicularly upward by the hologram pattern 205a. The remaining portion 208 of light reflects and circulates within the light guide plate. In FIG. 7, the reference number 203 indicates the YAG fluorescent layer, and 201 indicates the monochromatic light source. The construction of the invention as shown in FIG. 7 emits light 206a and 206b in a perpendicular direction.

As set forth above, the present invention employs the hologram pattern instead of the prism sheet to perpendicularly emit lateral incident light. Also the invention employs the monochromatic light source to prevent drawbacks such as chromatic dispersion, brightness loss and efficiency degradation resulting from the hologram pattern.

Further, the invention applies the fluorescent layer on the light guide plate to convert monochromatic light into white light of multi-wavelength to obtain white surface light for backlighting.

Moreover, the invention can realize white surface light without conventional optical elements such as a prism sheet and a diffuser plate to provide a light unit thinner than conventional ones, thereby reducing the thickness of an article and simplifying its design.

While this invention has been described in connection with the preferred embodiments in the specification of the invention, it is also to be understood that various modifications and variations can be made without departing from the scope and spirit of the invention, which is not restricted to the above described embodiments but shall be defined by the appended claims and equivalents thereof.

What is claimed is:

1. A light unit for a display device, comprising:
a monochromatic light source for emitting monochromatic light;
a light guide plate placed at the side of said monochromatic light source, and having a hologram pattern formed on at least one of front and rear faces oriented perpendicular to incident light introduced from said monochromatic light source for emitting light in a direction substantially perpendicular to the incidence direction of light; and
a fluorescent layer applied on said front face of the light guide plate for converting perpendicularly-directed emitted light into white light.

2. The light unit for a display device as set forth in claim 1, wherein said monochromatic light source comprises a blue light source for emitting blue light.

3. The light unit for a display device as set forth in claim 1, wherein said hologram pattern is formed on both of said front and rear faces of the light guide plate.

4. The light unit for a display device as set forth in claim 1, wherein said fluorescent layer contains Yttrium Aluminum Garnet (YAG) powder and binder for enabling application of said fluorescent layer on said light guide plate.

5. The light unit for a display device as set forth in claim 4, wherein said binder comprises transparent resin.

6. The light unit for a display device as set forth in claim 1, wherein said hologram pattern has a diffraction pitch of about 0.1 to 50 μm.

7. The light unit for a display device as set forth in claim 6, wherein said hologram pattern has a diffraction pitch of about 0.1 to 5 μm.

8. A light unit for a display device, comprising:
a monochromatic light source for emitting monochromatic light;
a light guide plate placed at the side of said monochromatic light source, and having a hologram pattern formed on at least one of front and rear faces oriented perpendicular to incident light introduced from said monochromatic light source for emitting light in a direction substantially perpendicular to the incidence direction of light;
a reflector placed under said rear face of the light guide plate; and
a fluorescent layer applied on said front face of the light guide plate for converting perpendicularly-directed emitted light into white light.

9. The light unit for a display device as set forth in claim 8, wherein said monochromatic light source comprises a blue light source for emitting blue light.

10. The light unit for a display device as set forth in claim 8, wherein said hologram pattern is formed on both of said front and rear faces of the light guide plate.

11. The light unit for a display device as set forth in claim 8, wherein said fluorescent layer contains Yttrium Aluminum Garnet (YAG) powder and binder for enabling application of said fluorescent layer on said light guide plate.

12. The light unit for a display device as set forth in claim 11, wherein said binder comprises transparent resin.

13. The light unit for a display device as set forth in claim 8, wherein said hologram pattern has a diffraction pitch of about 0.1 to 50 μm.

14. The light unit for a display device as set forth in claim 13, wherein said hologram pattern has a diffraction pitch of about 0.1 to 5 μm.
